(19) United States
(12) Patent Application Publication
(10) Pub. No.: US 2017/0307925 A1
(43) Pub. Date: Oct. 26, 2017

(54) LIQUID CRYSTAL DEVICE

(71) Applicant: Cambridge Enterprise Limited, Cambridge (GB)

(72) Inventors: Daping CHU, Cambridge (GB); Kun LI, Cambridge (GB)

(73) Assignee: Cambridge Enterprise Limited, Cambridge (GB)

(21) Appl. No.: 15/510,157

(22) PCT Filed: Oct. 9, 2015
(86) PCT No.: PCT/GB2015/052966

§ 371 Date: Mar. 9, 2017

(30) Foreign Application Priority Data
Oct. 9, 2014 (GB) 1417876.8
Jul. 16, 2015 (GB) 1512482.9

(51) Int. Cl. G02F 1/1339; C09K 19/12; C09K 19/40; G02F 1/1343; G02F 1/1333; C01G 19/00; C09K 19/60; G02F 1/137; C09K 19/54

(52) U.S. Cl. CPC G02F 1/13394; G02F 1/13781; C09K 19/12; C09K 19/406; G02F 1/13439; C09K 19/542; G02F 1/133365; C01G 19/006; C09K 19/60; G02F 1/134309; C01P 2006/40; G02F 2001/13398; G02F 2201/122; C09K 2019/122

(57) ABSTRACT

A liquid crystal device and a method of forming a liquid crystal device are disclosed. The device comprises a layer of liquid crystal material bounded by a first cell wall and a second cell wall, the first cell wall being provided with a first electrode structure and the second cell wall being provided with a second electrode structure. The first cell wall and the second cell wall are separated by a distance d_{c}, wherein the layer of liquid crystal material is associated with a plurality of defect generation sites. Defects are generated by the defect generation sites, increasing switching speed and decreasing the time it takes to switch large area displays employing such devices.

The present invention relates to a liquid crystal device and a method of forming a liquid crystal device.

Liquid crystal (LC) devices are well known in many fields of use. For example, one common usage is in the form of a display device, typically for displaying images or other information, for example, in visual display units or televisions. Typically currently commercially available LC-based devices utilise nematic liquid crystal materials, where on the application of an electric field the individual rod-shaped molecules within the liquid crystal material align in a common orientation, such that the long axes of each molecule (the director) are parallel. Such devices require continuous power consumption for the molecules to remain in this oriented state, and are therefore known as monostable. The requirement for power consumption to maintain this state can be a disadvantage for some applications, such as semi-static information displays, and then the monostability of the device can be a disadvantage for others, such as smart glazing.

Other types of liquid crystal materials are capable of bistable, as opposed to monostable, behaviour, where the material is stable in two states. One example of this are Smectic liquid crystal materials, which are generally characterised by forming liquid crystal phases having a well-defined layered structure. Within the layers the molecules of the liquid crystal material exhibit both orientational ordering (as with nematic liquid crystals above) and a degree of positional ordering. Suffixed in order of discovery, Smectic A liquid crystal materials are the most common Smectic liquid crystal phase, which with the combination of both orientational and positional ordering exhibits a number of useful electro-optic effects. Within the liquid crystal phase molecules are generally found orthogonal to the layers, but with a random orientation distribution. To form devices, these liquid crystal phases are included in cells bounded by cell walls having electrode structures provided on their inner surfaces. It is necessary to employ a device addressing mode differentiated from the simple field addressing of nematic LC.

For the purposes of this discussion it is presumed that the dynamic scattering mode induced by co-doped ion-systems within the liquid crystal formulation.

The layered formation of the Smectic A phase confers distinct electro-optic properties on the liquid crystal materials, since the ionic motion within the molecular structure is preferentially along the layers rather than across the layers. In particular, in the presence of a low frequency electric field (<100 Hz), the flow of ionic dopant induces a highly scattering opaque state, where the distribution of the liquid crystal molecules is randomised. In the presence of higher or increasing frequency electric fields (>1 kHz) the ionic motion is damped out, resulting in dielectric reorientation of the molecules into an aligned state within the layers, causing the liquid crystal to appear clear. These two modes of operation create the bistable behaviour of the material. The layered structure of the Smectic A phase and the relatively high viscosity causes the molecules to be stable in either the clear or the opaque states in zero field, enabling low power consumption bistable electro-optic devices incorporating such liquid crystals to be envisaged.

In use therefore, in order to switch between the opaque and clear states an electric field must be applied to the Smectic A material. Typically this switching takes of the order of few hundred milliseconds, depending on the size of the device and the voltage applied. Switching speed tends to be inversely proportional to the dimensions of the liquid crystal device, with observational evidence suggesting that scattering of the liquid crystal molecules propagates from the edges of the device. Hence for large devices such as panels measuring several metres across, the switching speed may be of the order of a few seconds, as there will be an appreciable time delay in the propagation of the molecular scattering leading to the opaque state and vice versa. The speed of this scattering may be increased by increasing the applied voltage, although this has the disadvantage that too high an applied voltage causes localised hot spots or heat affected zones (HAZ) where arcing of the liquid crystal structure may occur. The efficiency of this scattering process is clearly therefore a limiting factor in the ability to create usable large-scale liquid crystal devices.

This efficiency has been considered previously in terms of providing improved optical brightness in bistable display devices in WO01/40853. A zenithal bistable device (ZBD) comprising a nematic liquid crystal phase is disclosed, carrying an alignment layer on one or both electrode structures within the liquid crystal cell. A variety of surface features are used to form alignment areas, separated by areas of monostable, homeotropic alignment. The alignment areas form regions of bistable alignment with differing values of pre-tilt, caused by the local variations in molecular alignment created by the surface features. The surface features may be regions of grating structures, protrusions from the electrode surface or blind holes in the electrode surface. The optical performance resulting from such local variations in scattering is found to be greatly improved.

However, whilst it is therefore understood that the optical properties of the scattering state can be influenced by modifying the surface roughness of the electrode structure by providing such surface features, the switching properties, in particular, switching speed, remain to be optimised. It is therefore desirable not only to be able to create optically satisfactory, large-scale, low-power bistable liquid crystal devices, but to be able to switch these at a speed unnoticeable to a user.

The present invention aims to address these issues by providing a liquid crystal device comprising: a layer of liquid crystal material bounded by a first cell wall and a second cell wall, the first cell wall being provided with a first electrode structure and the second cell wall being provided with a second electrode structure, and the first cell wall and the second cell wall being separated by a distance d_{c}, wherein the layer of liquid crystal material is associated with a plurality of defect generation sites.

Since each defect generation site will create a defect that is a randomised domain responsible for scattering by means of forming a region experiencing an electric field gradient on the application of an electric field, the provision of a plurality of such defect generation sites in the electrode structure leads to a decreased scattering time compared with the use of plain electrode structures where no such defect generation sites are included. Unlike in the art, it is possible to create large-scale liquid crystal devices with minimal switching times by utilising such liquid crystal constructions.

Preferably the width of at least one defect generated by a defect generation site is w_{d}, wherein w_{d}>d_{c}. Alternatively, the width of one defect generated by a defect generation site is w_{d}, wherein w_{d}<5d_{c}. In this situation, it is most preferable that w_{d}<d_{c}. Preferably, the spacing between at least two adjacent defects generated by defect generation sites is d_{d}, and wherein d_{d}>d_{c}.

At least a first intermediate layer may be provided between the layer of liquid crystal material and at least one of the first and second electrode structures. This intermediate layer may be a pinning layer, and the pinning layer comprises the plurality of defect generation sites. Alternatively, this intermediate layer may be a dielectric layer, and the dielectric layer comprises the plurality of defect generation sites.

Preferably, at least one of the first and second electrode structures is multiconnected, such that the electrode structure comprises a plurality of defect generation sites.

More preferably, both the first electrode structure and the second electrode structure are multiconnected, such that both the first and second electrode structures comprise a plurality of defect generation sites. This enables the creation of additional fringe field effects when compared to the use of a single electrode structure comprising defect generation sites, with a consequential increase in switching speed.

Preferably, the plurality of defect generation sites extends substantially across the electrode structure. Covering at least a portion of or all of the electrode structure with defect generation sites also increases the switching speed.

Preferably, the plurality of defect generation sites comprises an array of defect generation sites. The density of defect generation sites may be approximately constant across the electrode structure. Alternatively, a first density of defect generation sites is present in a first region of the electrode structure and a second density of defect generation sites is present in a second region of the electrode structure, and wherein the first density is different to the second density. This leads to a non-uniform variation in switching speed that may be advantageous for certain applications. The width of each defect generation site in the array may be substantially equal for each defect generation site in the array. In this situation the influence on switching times is the same for each defect generation site.

Preferably, the defect generation site is a through hole, having a width wₕ, in the electrode structure.

Alternatively, the one of the at least first or second electrode structure comprising the defect generation sites may be patterned, the pattern comprising regions of materials with different work functions, such that the differences in work functions create the defect generation sites.

As a further alternative, at least a first intermediate layer may be provided between the layer of liquid crystal material and at least one of the first and second electrode structures, and wherein the liquid crystal material, the electrode structure and the intermediate layer are formed of materials or surfaces each having a work function, such that the differences in work functions create the defect generation sites.

Preferably, liquid crystal material is a Smectic A liquid crystal material. The liquid crystal material may be a mixture of Smectic A liquid crystal material with polymers and/or colourants.

The Smectic A liquid crystal material may be an Organic-based Smectic A liquid crystal material, alternatively, the Smectic A liquid crystal material may be a Siloxane-based Smectic A liquid crystal material.

Preferably, the electrodes are made of transparent metal oxide material, such as indium tin oxide (ITO) material. Alternatively, the electrodes may be made of carbon based material, such as a graphene material.

Preferably, when in use, the plurality of defect generation sites lead to the generation of an electric field gradient. At least one cell wall may comprise a flexible material. Alternatively or additionally, at least one cell wall may comprise a rigid material

In a second aspect, the present invention also provides a method of preparing a liquid crystal device, comprising the steps of: providing a first substrate having an electrically conductive coating that forms a first electrode structure; providing a second substrate having an electrically conductive coating that forms a second electrode structure; assembling the first substrate and the second substrate with a liquid crystal material to form a first cell wall and a second cell wall separated by a distance d_{c} and having a layer of liquid crystal bounded between them; and associating the layer of liquid crystal material with a plurality of defect generation sites.

Preferably, the step of associating the layer of liquid crystal material with the plurality of defect generation sites comprises providing either an intermediate layer, wherein the intermediate layer comprises the plurality of defect generation sites, or treating the electrically conductive coating to provide a plurality of defect generation sites.

Preferably, treating the electrically conductive coating comprises removing at least a portion of the electrically conductive coating. More preferably, treating the electrically conductive coating comprises removing at least a portion of the electrically conductive coating to create a through hole. Use of through holes results in an electric-field based improvement of switching speed.

Preferably, the step of treating the electrically conductive coating comprises using a laser. Alternatively, the step of treating the electrically conductive coating comprises using photolithography. More preferably, the method further comprises the step of treating the second electrically conductive coating on the second substrate to provide a plurality of defect generation sites.

The invention will now be described by way of example only, and with reference to the accompanying drawings, in which;

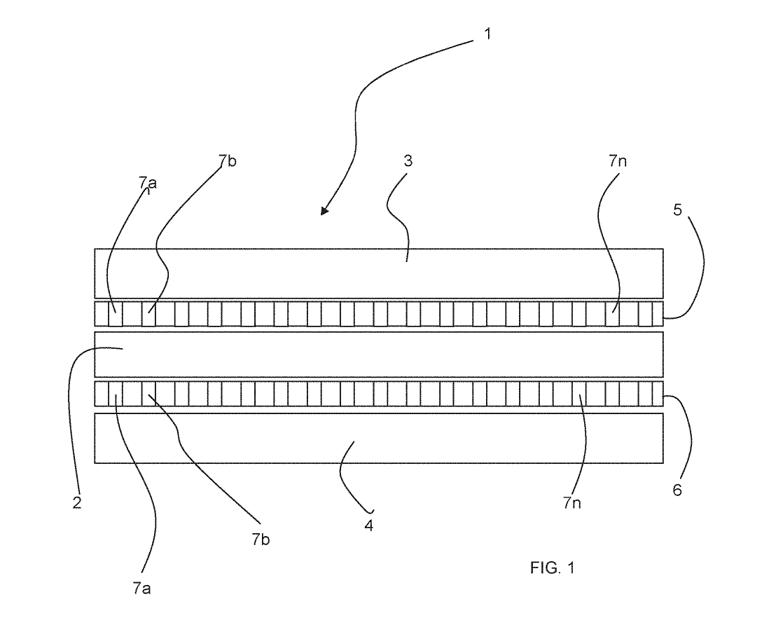

FIG. 1 is a schematic cross-sectional view of a liquid crystal device comprising a Smectic A liquid crystal phase in accordance with an embodiment of the present invention;

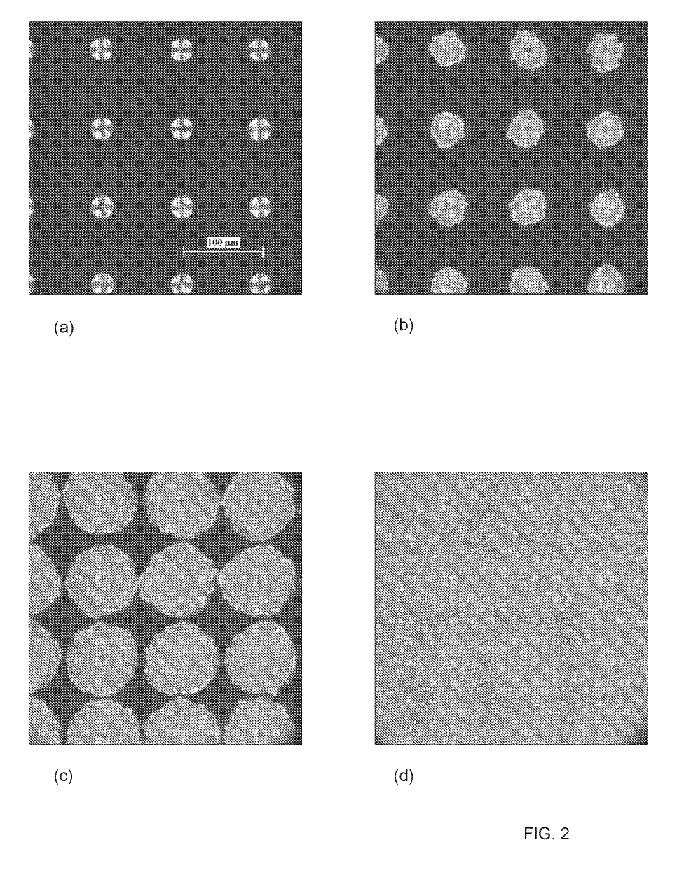

FIGS. 2a to 2d are micrographs showing the propagation of scattering with time for a liquid crystal device in accordance with an embodiment of the present invention;

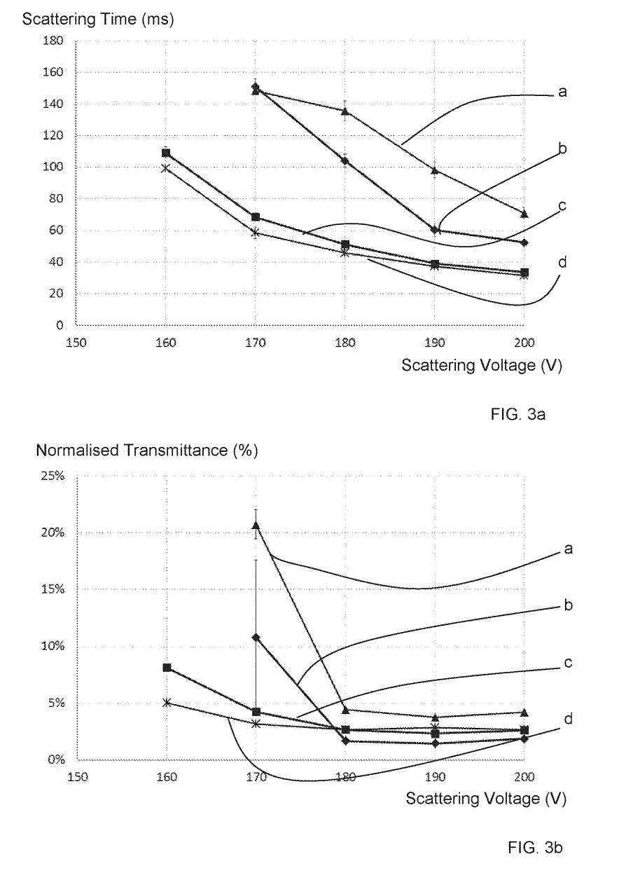

FIG. 3a is a chart showing the comparison in scattering times for liquid crystal devices in accordance with an embodiment of the present invention and a reference device;

FIG. 3b is a chart showing the comparison in optical transmittance in the scattered state for liquid crystal devices in accordance with an embodiment of the present invention and a reference device;

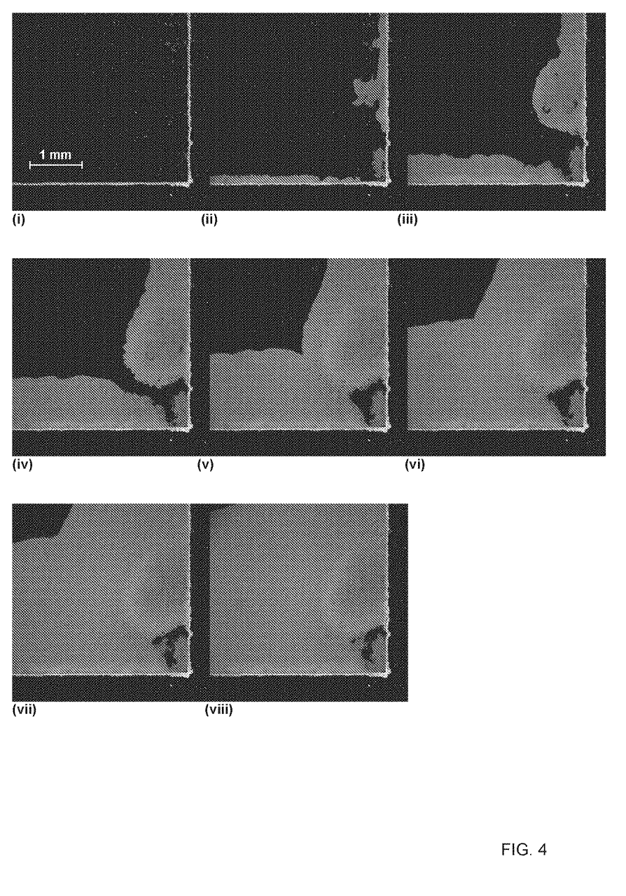

FIG. 4 is an image illustrating the scattering propagation process responsible for the change in transmittance of a reference device, with FIGS. 4(i) to 4(viii) showing propagation with increasing time;

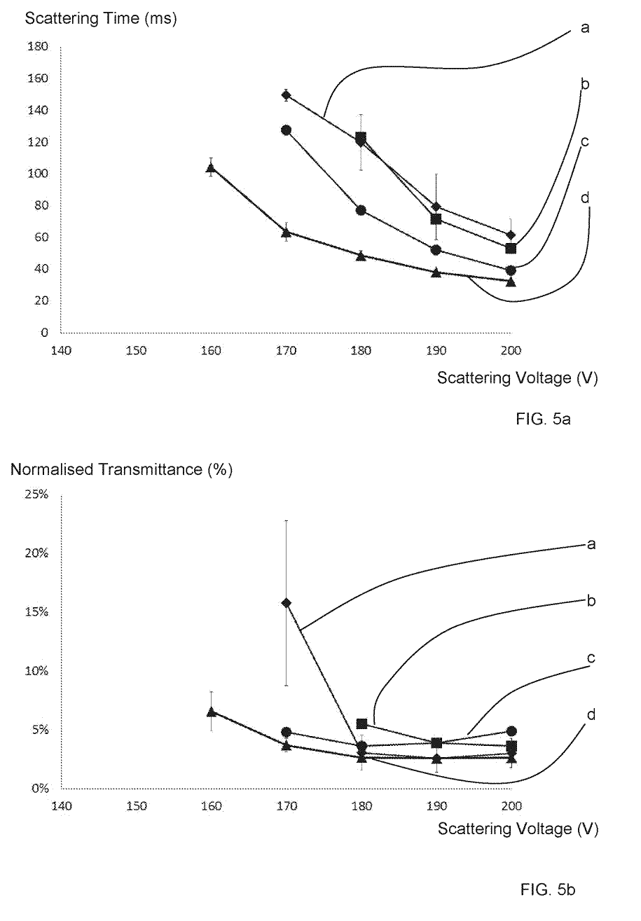

FIG. 5a is a chart showing the variation in scattering time and voltage for various defect generation site configurations for an Organic-based Smectic A liquid crystal phase;

FIG. 5b is a chart showing the variation in optical transmittance with scattering voltage for various defect generation site configurations for an Organic-based Smectic A liquid crystal phase;

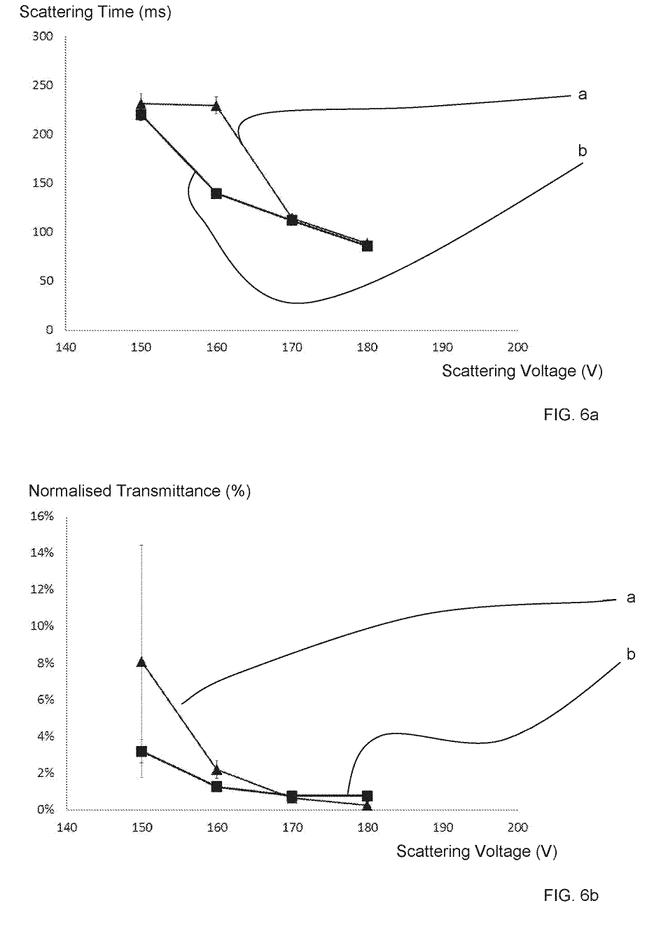

FIG. 6a is a chart showing the variation in scattering time and voltage for various defect generation site configurations for a Siloxane-based Smectic A liquid crystal phase;

FIG. 6b is a chart showing the variation in optical transmittance with scattering voltage for various defect generation site configurations for a Siloxane-based Smectic A liquid crystal phase;

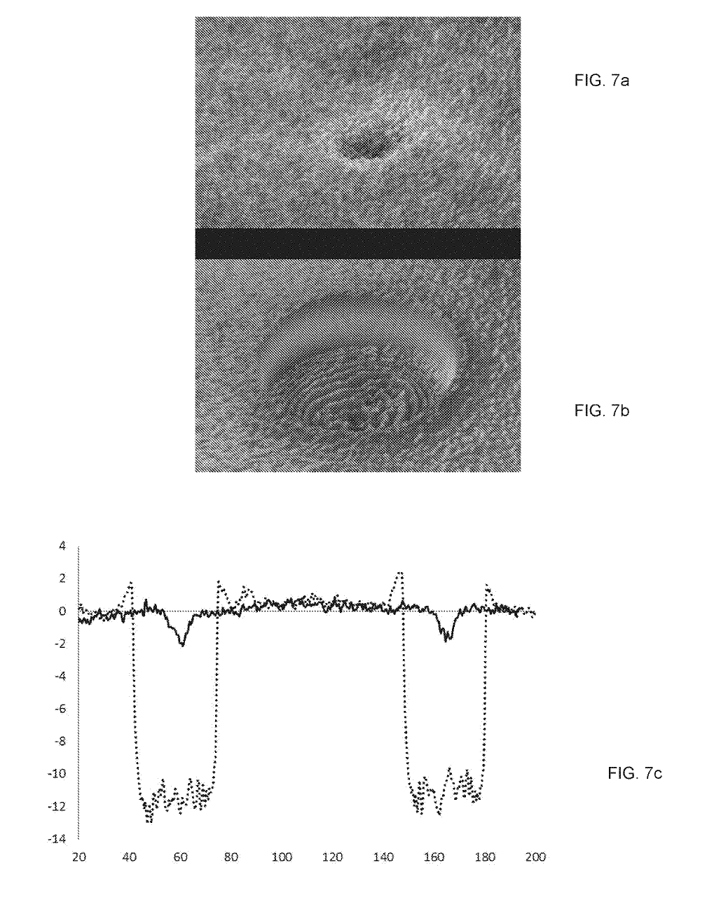

FIG. 7a is a micrograph showing a blind hole in the ITO coating of the electrode structure for use with liquid crystal devices in accordance with various embodiments of the present invention;

FIG. 7b is a micrograph showing a through hole in the ITO coating of the electrode structure for use with liquid crystal devices in accordance with the first embodiment of the present invention;

FIG. 7c is a depth profile of both the blind holes of FIG. 7a and the through holes of FIG. 7b;

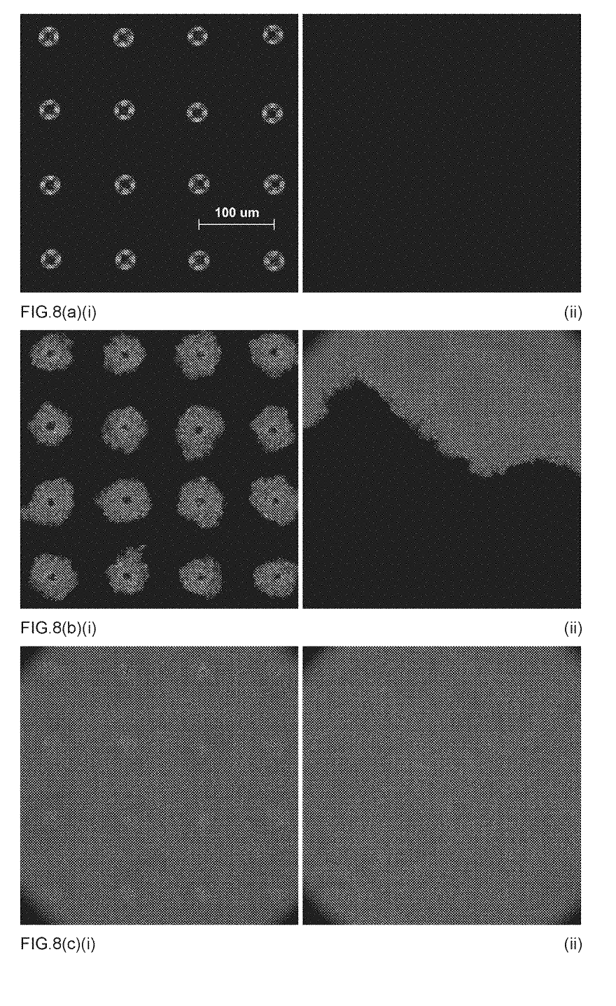

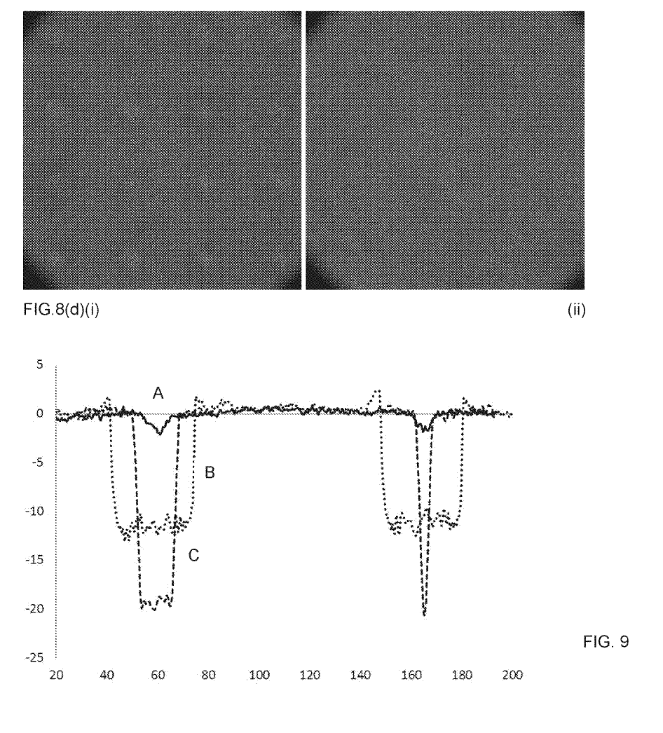

FIG. 8a shows micrographs of the clear state for a liquid crystal device embodying the present invention utilising (i) through holes and a comparison utilising (ii) blind holes;

FIG. 8b shows micrographs of a liquid crystal device embodying the present invention utilising (i) through holes and a comparison utilising (ii) blind holes in a half scattered state using a low scattering voltage;

FIG. 8c shows micrographs of a liquid crystal device embodying the present invention utilising (i) through holes and a comparison utilising (ii) blind holes in a fully scattered state using a high scattering voltage;

FIG. 8d shows micrographs of a liquid crystal device embodying the present invention utilising (i) through holes and a comparison utilising (ii) blind holes in the fully scattered state after removal of the applied voltage;

FIG. 9 is a depth profile comparing (A) laser-formed blind holes, (B) laser-formed through holes and (C) photolithographic through holes;

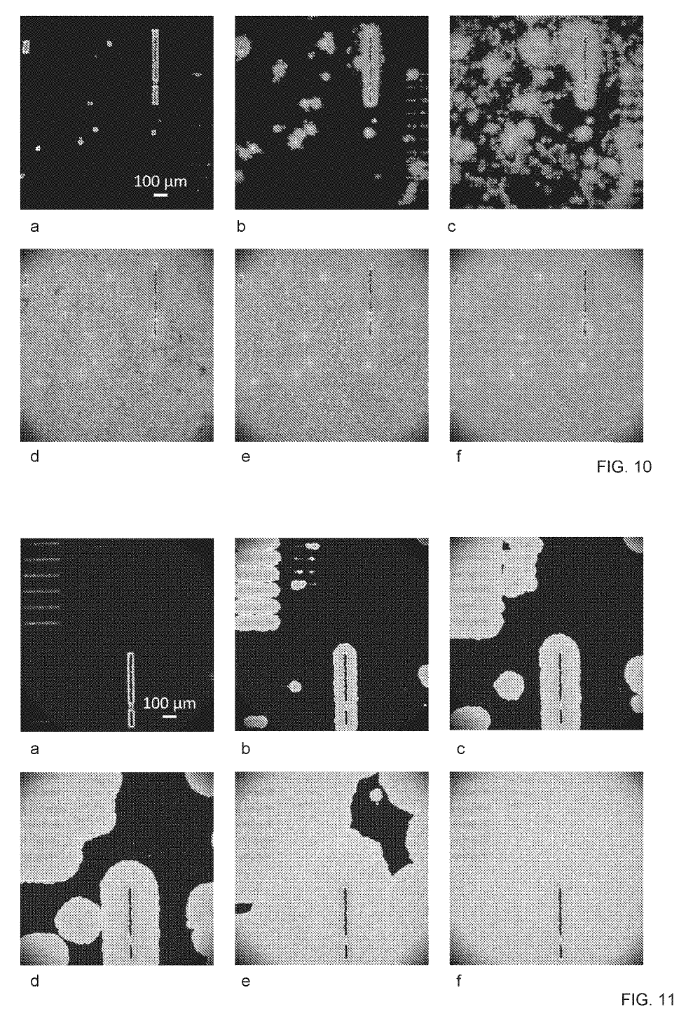

FIGS. 10a to 10f are micrographs showing scattering with time for an Organic-based Smectic A liquid crystal device in accordance with an embodiment of the present invention; and

FIGS. 11a to 11f are micrographs showing scattering with time for a Siloxane-based Smectic A liquid crystal device in accordance with an embodiment of the present invention.

In order to obviate the issues discussed above, the present invention takes the approach that the observational and anecdotal evidence of switching mechanisms involving scattering of molecules can be employed to increase switching speed without detriment to the structure of the liquid crystal device. When liquid crystal cells are examined during application of an electric field, often, scattering is observed to propagate from the edge of the liquid crystal cell toward the centre. Without wishing to be bound by theory, it is believed that the scattering of Smectic A liquid crystals is as a result of randomised domains. These domains are caused by the generation of continuous defects within the liquid crystal material, where such defects are generated more easily in regions where there is a large electric field gradient. Hence when an external scattering waveform (applied electric field of desired frequency) is applied to the edges of the electrodes of the cell, scattering is observed to spread outwards from these edges to the cell centre. With this in mind, the present invention proposes that the switching speed of a liquid crystal device comprising a layer of liquid crystal material bounded by a first cell wall and a second cell wall can be increased by providing a plurality of defect generation sites. In practice, by the first cell wall is provided with a first electrode structure and the second cell wall is provided with a second electrode structure. The first cell wall and the second cell wall are separated by a distance d_{c}. The layer of liquid crystal material is associated with a plurality of defect generation sites. As discussed below these can be provided in a number of ways. Preferably, at least one of the first and second electrode structures comprises the plurality of defect generation sites. However, it is also possible to exploit various other effects to create such defects, including modifying a pinning layer, modifying a dielectric layer, providing layers with different work functions or patterning an electrode with materials with different work functions. However, regardless of the method by which such sites are formed, by providing such sites the number of randomised domains is increased leading to an increase in scattering speed and therefore switching speed, without detriment to the structure or integrity of the cell or liquid crystal material.

It has also been appreciated that a liquid crystal device exhibiting increased switching times can be fabricated easily. By providing a first substrate having an electrically conductive coating that forms a first electrode structure and a second substrate having an electrically conductive coating that forms a second electrode structure, it is possible to assemble the first substrate and the second substrate with a liquid crystal material to form a first cell wall and a second cell wall separated by a distance d_{c} and having a layer of liquid crystal bounded between them. By associating the layer of liquid crystal material with a plurality of defect generation sites, such a liquid crystal device is formed. Associating the layer of liquid crystal material with the plurality of defect generation sites may be done either by providing either an intermediate layer, wherein the intermediate layer comprises the plurality of defect generation sites, or treating the electrically conductive coating to provide a plurality of defect generation sites. Removing at least a portion of the electrically conductive coating, and in particular, removing at least a portion of the electrically conductive coating to create a through hole, enable this association to take place. This may be done whether at least one cell wall comprises a flexible material, and/or at least one cell wall comprises a rigid material.

Using a laser to remove the electrically conductive coating is particularly advantageous in terms of cost and ease of processing, as well as giving good results and improved switching times.

FIG. 1 is a schematic cross-sectional view of a liquid crystal device comprising a Smectic A liquid crystal phase in accordance with an embodiment of the present invention. The liquid crystal cell 1 comprises a layer of liquid crystal material 2 bounded by a first cell wall 3 and a second cell wall 4. The first cell wall 3 is provided with a first electrode structure 5 and the second cell wall 4 is provided with a second electrode structure 6. The first cell wall 3 and the second cell wall 4 are separated by a distance d_{c}, known as the cell gap. The first electrode structure 5 and the second electrode structure 6 are provided with a plurality of defect generation sites 7a, 7b . . . 7n. Each defect generation site 7a, 7b . . . 7n is a through hole having a width wₕ. In this embodiment, the first 3 and second 4 cell walls are formed from a glass substrate, with the first 5 and second 6 electrode structures being formed from an indium tin oxide (ITO) coating on the inner surfaces of the first 3 and second 4 cell walls respectively. The through holes 7a, 7b . . . 7n extend substantially the entire thickness of the ITO coating, and may expose the glass substrate beneath, depending on the manufacturing method. For example, if a laser is used there may be some partial melting of the ITO coating into the substrate, causing a loss of electrical conductivity, whereas if a photolithography method is used the ITO coating is removed completely, exposing the substrate. Therefore the term “through hole” should be understood to mean a hole extending through the electrode structure sufficiently to prevent electrical conductivity at that point. The through holes 7a, 7b . . . 7n are spaced apart by a distance dₕ.

The creation of through holes 7a, 7b . . . 7n in the electrode structure 5 provides both field emitters and a continuous field over the entire electrode structure due to field penetration into the liquid crystal material. In terms of the structure in FIG. 1, a fringe field effect around the edges of the holes causes the field to appear to be continuous. Consequently, although the actual size and spacing of the defect generation sites 7a, 7b . . . 7n is determined by the switching voltage and dielectric properties of the liquid crystal material, as a general rule for fringe field effects to occur the width w_{d} of the defect should be smaller than the through hole width wₕ. However, the through hole width wₕ should preferably be not much smaller than the distance d_{c} separating the first 3 and second 4 cell walls, otherwise the electric field fringe effects that occur at opposite sides of the through hole will merge together reducing the electric field gradient. Moreover, the width of the defect w_{d} could be greater or smaller than the distance d_{c} separating the first 3 and second 4 cell walls depending on the through hole width wₕ, and the spacing d_{d} between two adjacent defects may also be greater or smaller than the distance d_{c} separating the first 3 and second 4 cell walls, depending on the spacing between the through holes dₕ. The distance d_{d} between two adjacent defects may also be greater or smaller than the width of the defects w_{d}. If d_{d}>w_{d}, the complete switching process comprises two parts: defect nucleation and domain growth, since there is no over lapping of defects. If d_{d}<w_{d}, nucleation only will be sufficient, which will increase the switching speed if more defects are provided. Through such arrangements, the switching speed of the whole cell may be controlled.

Typically, the fringe field effects occur over the order of twice the distance between the first 3 and second 4 cell walls, 2d_{c}, but may occur over greater or smaller distances. In some circumstances therefore it may be preferable that the width of the defects is less than five times the distance between the first 3 and second 4 cell walls, w_{d}<5d_{c}, more preferably less than twice the distance between the first 3 and second 4 cell walls, w_{d}<2d_{c}, and yet more preferably the width of the defects should be less than the distance between the first 3 and second 4 cell walls, w_{d}<d_{c}. The combination of a smaller spacing between two adjacent defects d_{d} and a smaller width w_{d} of the defect distributed randomly over the surface of the first 5 and/or second 6 electrodes is that a discontinuous electric field is generated, which, as explained in further detail below, aids in increasing switching speed. The use of electric field fringe effects, as well as the generation of an electric field gradient, to cause switching uniformly over a wide area, represents a great improvement over prior systems where large areas are switched using perpendicular electric fields initiated from the periphery of the electrodes.

In order to determine firstly, whether the scattering speed and therefore the switching speed was increased using such an approach, and secondly, the mechanism by which such increased speed was obtained, a series of experiments as described in the examples below was carried out on various Smectic A materials.

Test cells were fabricated as follows. A transparent conductive layer (typically indium tin oxide (ITO)) was applied to the inner surface of two planar glass substrates to form electrodes. This in effect replicates the first 3 and second 4 cell walls described above. Spacers were deposited on the substrates, outside of the active area, to define the cell gap, which is typically in the region of 0.5 to 10 μm. In the following examples the cell gap is nominally 10 μm. An edge seal or adhesive was used to seal the cell, leaving apertures through which the Smectic A liquid crystal composition was filled. In the following, a patterned electrode is an electrode structure provided therein with defect generation sites, and an unpatterned electrode is a plain electrode structure with no defect generation sites provided therein.

### EXAMPLE 1

### 1.1 Preparation of a Patterned Electrode

Glass coated with ITO was cleaned and chemically etched in a clean room. Sticky tape (10 mm wide) was used to cover the active area which was not removed by chemical etching. A number of evenly-spaced holes were machined with an Infrared (IR, 1065 nm wavelength) fibre laser, G3 Single Mode SM-S00044_1, available from SPI Lasers UK Ltd, 6 Wellington Park, Tollbar Way, Hedge End, Southampton, Hampshire S030 2QU, UK on the ITO-coated glass. The IR fibre laser used is driven by a scanning system, which controls the location and sizing of the features of the pattern. The diameter of the machined holes depends on the laser pulse energy and the number of pulses used. The minimum diameter achieved by the IR laser on an ITO-coated glass substrate was ˜20 μm, and this formed the basis of the hole size. The Gaussian or Gaussian-like spatial profile of the laser output was such that a central zone that defines the minimum feature size actually removes material whereas the remainder of the incident beam merely contributes to the heat affected zone (HAZ).

The hole or defect generation site density is defined as the number of holes or sites per mm² in the electrode structure. The pattern density is defined as the ratio of the sum of the circumference of all the holes, to the patterned area. Holes were patterned on one side of the ITO-coated glass, and the active area, i.e. the area filled with LC was 10×10 mm², so there were 10,000 holes for 100 μm spaced patterns and the hole density was therefore 100 per mm². In each example below, the through holes are substantially circular and positioned in a regular array.

### 1.2 Preparation of Test Cells

In order to determine the effect of the electrode patterning on the scattering effect of the cell, test glass cells incorporating the patterned electrode prepared in example 1.1, using a cyanbiophenyl Smectic A liquid crystal composition, specifically 4-cyano-4′-n-octyl biphenyl (8CB). Test cells were also prepared with unpatterned electrodes to serve as reference cells. The cell gap d_{c} was ˜10 μm.

### 1.3 Analysis of Cells Comprising Patterned/Unpatterned Electrodes

### 1.3.1 Scattering

The cells prepared using the patterned and unpatterned electrodes were subjected to ten±180 V and 40 Hz square wave pulses and the results were recorded by as follows. The test cells were placed between cross-polarisers under a microscope (Olympus BX51, available from Olympus, Japan) and a high speed camera (CR600×2, available from Optronis, Germany) mounted on the microscope. When test cells are in a clear state, the liquid crystal cells are homeotropically aligned and the cells appear dark as light is blocked by the crossed polarisers. When the cells are in the scattered state, the liquid crystal molecules appear in a random aligned state, where the polarisation of the light is changed randomly, such that the cells appear bright.

### 1.3.2 Transmittance

The transmittance response of the test cells was measured as follows. A red laser (LE07 operating at 650 nm, 1 mW, and available from Maplin, UK) was used to illuminate the centre of the test cells. The laser had a 2.8 mm beam aperture such that the recorded transmittance change had an average value over the 2.8 mm aperture area. A silicon-based photodiode (having a 10×10 mm photosensitive area and a response range of 240-1100 nm) and fabricated by the inventors, was used to monitor the change in laser intensity for laser light passed through the test cell. IGOR WaveMetrics software was used to generate the driving signals (±10V maximum) together with a ×20 voltage amplifier (A400D, available from FLC Electronics), such that high voltage driving signals were obtained. The IGOR software was also used to record the analogue signal from the photodiode via a data acquisition card (NI PCI6221 37Pin) and digitized into measured data. The maximum laser intensity as measured with no cell in the beam path was used as a reference, with measured transmittance being normalised with respect to this maximum intensity.

### 1.4 Results

The results of these tests are shown in FIGS. 2a to 2d, which are micrographs showing the propagation of scattering with time for a liquid crystal device in accordance with the present invention. FIG. 2a shows the SmA cell formed with the patterned electrode (100 μm spaced pattern) before scattering. FIG. 2b shows the cell 32 ms after scattering, FIG. 2c at 92 ms after scattering and FIG. 2d at 168 ms after scattering (fully scattered). From these images it is apparent that the edges of the patterned holes act as disruption regions in the electrodes when voltage signals are applied. The scattering starts uniformly from the patterned regions (hole rims) and propagates to the rest of the active area.

FIG. 3a is a chart showing the comparison in scattering times for liquid crystal devices in accordance with an embodiment of the present invention and a reference device. a) represents the first set of samples having no pattern, b) the second set of samples having no pattern, c) the first set of samples having a 100 μm spaced pattern and d) the second set of samples having a 100 μm spaced pattern. The results show that the cell comprising the patterned electrode demonstrated scattering (i.e. a change in transmittance from 90% to 10%) at approximately half the scattering time of the unpatterned cell. FIG. 3b is a chart showing the comparison in optical transmittance in the scattered state for liquid crystal devices in accordance with an embodiment of the present invention and a reference device. a) represents the second set of samples having no pattern, b) the first set of samples having no pattern, c) the first set of samples having a 100 μm spaced pattern and d) the second set of samples having a 100 μm spaced pattern. In addition, as can be seen from FIG. 3b, the transmittance was more consistent in the cells comprising the patterned electrodes. In particular at low driving voltages (160/170 V) the cells comprising the patterned electrodes achieved much lower transmittance values (<10%) than the cells comprising the unpatterned electrode. The driving parameters for the scattering measurements were ten square wave pulses at 40 Hz for each voltage, and for clearing the cell ten square wave pulses at 150 V at 2 kHz.

The results therefore show that reduced scattering time and more consistent transmittance values can be achieved for those liquid crystal cells comprising patterned electrodes. These results were based on a comparison of small glass cells, i.e. 10×10 mm². It is therefore to be expected that the differences in scattering time and scattering voltage will be greater for larger liquid crystal cells. The large cell with non-patterned electrode demonstrated initial scattering from the edges of the cell with propagation of the scattering to the centre. FIG. 4 is an image illustrating the scattering propagation process responsible for the change in transmittance, with FIGS. 4(i) to 4(viii) showing propagation with increasing time. Therefore, the propagation time can be expected to increase as the distance from the edge of the cell to the centre increases (i.e. for larger cells). In comparison, the scattering of the patterned cells started from the disruptible patterns in the electrodes, and the propagation time will therefore be dependent on the pattern density.

Assuming that the scattering time (Δt) consists of two parts: the generation time of the defects (Δt_{d}) and the propagation time of defect induced randomised domains (Δtₚ) from the site of defect generation to expand to the rest of the cell, i.e. the time needed to cover the whole cell area, then:

Δt=Δt_{d}+Δtₚ

### Sample 1:

For a non-patterned square cell (10×10 mm²) measured in this experiment, the recorded scattering time Δt₁ was 0.15 s when driven by ten square wave pulses of ±170 V at 40 Hz.

### Sample 2:

For a patterned square cell (10×10 mm²) with a density of 11.2 mm⁻¹ measured in this experiment, the recorded scattering time, Δt₂ was 0.07 s when driven under the same condition as of Sample 1 (ten square wave pulses of ±170 Vat 40 Hz). Assuming the propagation time in Sample 2 is negligible, Δt₂ may be considered as the defect generation time (Δt_{d}). Therefore, it is possible to calculate the propagation time in Sample 1 as Δtₚ=Δt−Δt_{d}=0.08 s for travelling 1.4 mm in distance from the edge of the detection laser bean spot to the centre in the 10×10 mm² cell. This gives a propagation speed in the order of 17.5 mm/s.

Based on the above, it is estimated that the scattering time for non-patterned cells will be ˜2.9 s for a 100×100 mm² cell, ˜28.6 s for a 1×1 m² cell, respectively, while the scattering time for patterned cells of the corresponding sizes should remain the same of 0.07 s, yielding an improvement of 40-400 times in switching time.

### EXAMPLE 2 EFFECT OF PATTERN DENSITY ON SCATTERING TIME AND TRANSMITTANCE

### 2.1 Organic-Based Smectic a Liquid Crystal

Patterned electrodes exhibiting varying pattern densities were prepared as described in Example 1.1 above. Liquid crystal cells (d_{c} 10 μm cell gap) comprising an Organic-based Smectic A liquid crystal using the cynanbiophenyl composition described above were then prepared as described in Example 1.2 above, with the liquid crystal region having a thickness of 10 μm. The travel distance of the cell, i.e. the furthest distance from the edge of a hole until the cell is scattered, was then calculated. FIG. 5a is a chart showing the variation in scattering time and voltage for various defect generation site configurations for an Organic-based Smectic A liquid crystal phase (where a) represents a travel distance of 1,400 μm, b) 336 μm, c) 159 μm and d) 53 μm), and FIG. 5b is a chart showing the variation in optical transmittance with scattering voltage for various defect generation site configurations for an Organic-based Smectic A liquid crystal phase (where a) represents a travel distance of 1,400 μm, b) 336 μm, c) 159 μm and d) 53 μm). Four configurations with various spacings between the through holes were used. The spacings determined the travel distances between the edge of the through hole and the furthest point reached by the scattering front as the scattering propagates through the Smectic A liquid crystal structure. As the number of through holes per square increases the travel distance decreases. Travel distances of 53 μm, 156 μm, 336 μm and 1,400 μm were used. Scattering time was measured as the time taken for the cell to change between 90% (clear) transmittance and 10% (opaque) appearance, as measured using the red laser measurement method described above. It can be seen that for all configurations as the applied voltage increases the scattering time decreases. However, it is also noticeable that as the travel distance decreases the scattering time decreases. The normalised transmittance in the scattered state is similar for all cells regardless of the travel distance (although the unstable transmittance of the cell with a travel distance of 1,400 μm should be noted). The driving parameters for the scattering measurements were ten square wave pulses at 40 Hz for each voltage, and for clearing the cell ten square wave pulses at 150 V at 2 kHz.

### 2.2 Siloxane-Based Smectic a Liquid Crystal

Patterned electrodes exhibiting varying pattern densities were prepared as described in Example 1.1 above. Liquid crystal cells (d_{c} 10 μm cell gap) comprising a Siloxane-based Smectic A liquid crystal were then prepared as described in Example 1.2 above. A Siloxane-based Smectic A liquid crystal is a liquid crystal composition based upon a Siloxane Smectic A material having various additives and/or modifications to the basic molecular structure or material composition to give either a higher or lower birefringence than an unmodified Siloxane Smectic A liquid crystal material. The travel distance of the cell, i.e. the furthest distance from the edge of a hole until the cell is scattered, was then calculated. FIG. 6a is a chart showing the variation in scattering time and voltage for various defect generation site configurations for a Siloxane-based Smectic A liquid crystal phase (where a) represents a spacing of 1,400 μm and b) 180 μm), and FIG. 6b is a chart showing the variation in optical transmittance with scattering voltage for various defect generation site configurations for a Siloxane-based Smectic A liquid crystal phase (where a) represents a spacing of 1,400 μm and b) 180 μm). Two configurations with various spacings between the through holes were used. The spacings determined the travel distances between the edge of the through hole and the furthest point reached by the scattering front as the scattering propagates through the Smectic A liquid crystal structure. As the number of through holes per square increases the travel distance decreases. Travel distances of 180 μm and 1,400 μm were used. Scattering time was measured as the time taken for the cell to change between 90% (clear) transmittance and 10% (opaque) appearance, as measured using the measurement method described above. It can be seen that for all configurations as the applied voltage increases the scattering time decreases. However, it is also noticeable that as the travel distance decreases the scattering time decreases. The normalised transmittance in the scattered state is similar for all cells regardless of the travel distance, although the unstable response of the cell with a 1,400 μm travel distance should be noted. The driving parameters for the scattering measurements were ten square wave pulses at 40 Hz for each voltage, and for clearing the cell ten square wave pulses at 150 V at 2 kHz.

### EXAMPLE 3 ASSESSMENT OF PROPAGATION SPEED AND SCATTER INITIATION TIME

3.1 Organic-based Smectic A liquid crystal

Propagation speed and scatter initiation time may be estimated using the following equation:

Δt=Δt_{d}+Δtₚ=Δt_{d}+Δdₚ/v

Where Δt is the total measured scattering time, Δt_{d} is the initiation time from the patterned defect generation sites, Δtₚ is the propagation time from patterned defect generation sites, Δdₚ is the propagation distance (the same as travel distance in FIGS. 5 and 6) assuming propagation speed u is linear. Δt_{d} and υ were solved based on this equation for cells with travel distances of 53 μm, 159 μm and 336 μm, respectively. The propagation speed u was found to increase exponentially with increasing voltage, although the initiation time Δt_{d} remained substantially constant, albeit with a tendency to decrease minimally at higher voltages.

### 3.2 Siloxane-Based Smectic a Liquid Crystal

The same calculation was carried out for the Siloxane-based Smectic A liquid crystal for both travel distances, 180 μm and 1,400 μm. In this material there was a general trend of increasing propagation speed with voltage and a decrease in initiation time from defects. Although the propagation speed was much higher than in the Organic-based Smectic A liquid crystal the initiation time was much longer.

From these results, a general trend of increasing scattering propagation speed with scattering voltage, and a decrease in scattering time from defects was observed. The propagation speed was much faster for the Siloxane-based SmA than for the Organic-based SmA, but it took much longer to scatter from defects.

### EXAMPLE 4 REQUIRED PATTERN DENSITY FOR OPTIMUM SCATTERING

Based on the above examples, the optimum pattern density was determined for each type of Smectic A liquid crystal. The value of d_{d} giving this optimum pattern density is shown in Table 1 below:

TABLE 1
optimum pattern densities in terms of d_{d} for two types
of LC in accordance with the present invention

| Driving Voltage | d_{d} (Organic-based SmA) | d_{d} (Siloxane-based SmA) |
|---|---|---|
| (V) | (mm) | (mm) |
| 150 | | 32.2 |
| 160 | | 2.44 |
| 170 | 0.095 | 101.8 |
| 180 | 0.208 | 57.3 |
| 190 | 0.407 | |
| 200 | 0.583 | |

The differences in the optimum pattern density for each type of Smectic A liquid crystal material reflect the differences in propagation speed observed.

In the light of these results providing through holes in the electrode structure of at least one wall of a cell containing Smectic A liquid crystal material increases the switching speed between the clear and opaque states regardless of applied voltage. However, as discussed above, it is presently believed that this is due to electric field effects, rather than the influence of surface roughness as with the optical scattering effects seen in the art. In order to investigate the relevance of electric field effects further, samples were prepared to compare the influence of through holes (as above) with blind holes (holes extending only partway through the ITO coating forming the electrode structure). For each sample a 10×10 mm² cell was formed with both through and blind holes having a hole spacing of 100 μm. As with the examples above, both the through holes and the blind holes were formed using an IR wavelength fibre laser, with a reduced laser power used to form the blind holes, resulting in a feature only a few nanometres deep. This is illustrated in FIGS. 7a-7c. FIG. 7a is a micrograph showing a blind hole in the ITO coating of the electrode structure for use with liquid crystal devices in accordance with various embodiments of the present invention. FIG. 7b is a micrograph showing a through hole in the ITO coating of the electrode structure for use with liquid crystal devices in accordance with the first embodiment of the present invention. A circular feature with marginally raised edges around the circumference is seen, with evidence of ITO remaining at the bottom of the through hole. The through hole is shallower than the depth of the ITO coating forming the electrode structure, indicating the occurrence of partial melting of the ITO into the glass substrate, resulting in a loss of electrical conductivity. The raised edges of the through hole indicate that the molten ITO re-solidified at the rim of the through hole. It can also be seen that although there is some evidence of re-solidification of the ITO coating around the rim of the blind hole, there is no pronounced rim as with the through hole. FIG. 7c is a depth profile of both the blind holes (solid line) of FIG. 7a and the through holes (dotted line) of FIG. 7b. It can be seen that the depth of the blind hole is only a fraction of the depth of the through hole, resulting in little effect on electrical conductivity.

FIG. 8a shows micrographs of the clear state for a liquid crystal device embodying the present invention utilising (i) through holes and a comparison utilising (ii) blind holes. Note that the sample with blind holes appears to be completely transparent, whereas on the scale used the through holes are easily discernible. However, this does not mean that such features would be easily seen in a real life device by the user. FIG. 8b shows micrographs of a liquid crystal device embodying the present invention utilising (i) through holes and a comparison utilising (ii) blind holes in a half scattered state using a low scattering voltage. The voltage used was approximately ±150V at 40 Hz. It can be seen that scattering in the sample with through holes shows propagation of the scattering extending outwards from each hole, whereas in the sample with blind holes, scattering propagates from one edge. FIG. 8c shows micrographs of a liquid crystal device embodying the present invention utilising (i) through holes and a comparison utilising (ii) blind holes in a fully scattered state using a high scattering voltage. The voltage used was approximately ±200V at 40 Hz. On close inspection it can be seen that the through holes are still visible within the scattered state. FIG. 8d shows micrographs of a liquid crystal device embodying the present invention utilising (i) through holes and a comparison utilising (ii) blind holes in the fully scattered state after removal of the applied voltage. This represents the opaque state of a bistable device. The sample with through holes appears to be more uniform in appearance than that with the blind holes.

Scattering times with applied voltage (square wave, ±200V, 40 Hz) were also measured to determine the effect on switching time of using blind holes compared with through holes. Times were measured by monitoring the transmittance of red laser light at 90% and 10% of the maximum transmittance value. For the sample with through holes, the switching time was 0.05 s, whereas for the sample with blind holes it was almost five times longer at 0.24 s. However, it is likely given the variation in experimental data observed that the difference is closer to twice as long to switch for the sample with blind holes.

The increase in switching speed for the sample with through holes supports the view that it is electric field effects that are responsible for the defect generation that results in the creation of randomised domains and not the influence of surface roughness. In the above examples both the first and the second electrode structures are patterned, i.e. provided with through holes forming defect generation sites. However, it may be desirable to have only one electrode structure provided with defect generation sites or through holes, as in the examples above, therefore the use of two such electrode structures should not be seen as limiting the present invention, since fringe field effects will be created with the use of at least one such electrode structure.

In the above examples, through holes have been provided in the ITO coating forming the electrode structure using an IR laser. Treating the electrically conductive ITO coating in this manner results in at least a portion of the coating being removed, with this creating a through hole. Each through hole was approximately circular as a result of the pulse shape of the laser. However, many other techniques may be suitable for forming through holes, and/or through holes need not be circular in shape. Suitable techniques for treating the electrically conductive ITO coating forming the electrode structure include, but are not limited to, dip pen transfer, gravure printing, laser ablation direct write imaging, laser ablation image projection, laser induced thermal imaging, laser induced plasma spectroscopy (LIPS), matrix-assisted pulsed laser evaporation (MAPLE), liquid coat spinodal dewetting, micro screen printing, nano dispersion digital inkjet printing, nano-embossed coating, offset printing, plasma etching, physical vapour deposition (PVD) and surface energy modified liquid coating patterning. However, one technique investigated in particular due to the ability to create through holes that expose the substrate forming the cell wall was photolithography.

To form through holes, a photo resist layer was coated onto the surface of the ITO coating forming the electrode structure on a glass substrate. A patterned mask with a regular array of through holes with an elongate shape (rod-shaped) was placed over this. This was subsequently exposed to create a photolithographic image in the photo resist layer, and developed. The substrate was then placed in an etching solution and chemically etched to remove the undeveloped photo resist and corresponding ITO coating layer. This resulted in an electrode structure with a regular array of elongate through holes across the surface. FIG. 9 is a depth profile comparing (A) laser-formed blind holes, (B) laser-formed through holes and (C) photolithographic through holes. As can be seen in FIG. 9, the through holes created using the photolithographic method extend through the entire ITO coating to the substrate, whereas as discussed above, the blind holes and through holes created using laser processing do not. In this respect the photolithographic through holes are functionally equivalent to the laser through holes as each create areas where there is no electrical conductivity.

In order to confirm this functional equivalence, the scattering behaviour of various cells was observed. FIGS. 10a to 10f are micrographs showing scattering with time for an Organic-based Smectic A liquid crystal device in accordance with an embodiment of the present invention; and FIGS. 11a to 11f are micrographs showing scattering with time for a Siloxane-based Smectic A liquid crystal device in accordance with an embodiment of the present invention. Both FIG. 10a and FIG. 11 a show the cell in the clear state. FIGS. 10b-10f and 11b-11f show the increase in scattering with increasing voltage (300V, 320V, 340V, 360V and 380V, all with square wave pulses at 40 Hz) until the cell reaches the scattered state and is opaque. It is clear that neither the method used to create the through holes, nor their shape, have a detrimental impact on the behaviour of the cells.

Aside from the photolithographic samples, the examples above comprise a regular array of defect generation sites in the form of circular through holes. However, it may be desirable to use through holes of a different shape or configuration, as with the photolithographic samples. For example, through holes may be elongate (rod-shaped), circular, regular geometric shapes, or irregular geometric shapes, and may extend uniformly though the ITO coating forming the electrode structure or may have variations in shape with depth, for example, may be tapered or stepped. The arrays considered are regular, such that the density of defect generation sites is approximately constant across the electrode structure. However, it may be desirable for there to be a first density of defect generation sites present in a first region of the electrode structure and a second density of defect generation sites to be present in a second region of the electrode structure, with the first density being different to the second density. This leads to variations in the number of defect generation sites in particular regions of the cell, so for example, a greater number of defect generation sites may be present in the central region of a large cell, to improve switching time at the points furthest from the edges of the cell. Ideally, the width wₕ, which for a circular through hole is the diameter of the through hole, of each defect generation site in the array is substantially equal for each defect generation site in the array, as in the examples above. However, it may be desirable for the width of the defect generation sites to be different, or for sites to have different shapes and configurations in the same electrode, or in different electrodes within a cell.

In the above examples, the defect generation sites are included within at least one of the electrode structures. This is a simple and effective way to ensure that the layer of liquid crystal material is associated with defect generation sites. However, other forms of defect generation sites may be used to create electric field gradients and thus increase switching speed in accordance with the present invention. One manner in which this may be achieved is by providing an intermediate layer between the layer of liquid crystal material and at least one of the first and second electrode structures. For example, a pinning layer may be used. A pinning layer is a layer that encourages the alignment of the liquid crystal molecules in the clear state, typically by creating areas of localised roughness. One example of this is the use of a grating structure in azimuthal and zenithal bi-stable Smectic A liquid crystal devices. By careful choice of material used to form the pinning layer a discontinuous electric field can be formed, leading to electric field gradient effects due to the creation of defect generation sites. To do this, the electrode surface may be regarded as being multiconnected, where a plurality of defect generation sites effectively work together to create a discontinuous electric field. This may be due to the random positioning of the defect generation sites across the surface of the electrode. This is in addition to any optical effects created as a result of the surface roughness, as in WO01/40853 above. As another alternative, it is possible to use a dielectric material as the intermediate layer, thus creating a discontinuous electric field due to the behaviour of the dielectric material under the influence of an applied voltage, resulting in defect generation sites. Again, the patterning of the dielectric material as well as its dielectric response determines the electric field gradient formation and consequential fringe field effects. A third alternative is to utilise the influence on electric field generation created by materials having different work functions. This may be done by ensuring that the layer of liquid crystal, electrodes and any intermediate layer have different work functions, or by patterning at least one of the first and second electrode structures using materials or surfaces having different work functions to create the defect generation sites. In this context, patterning the first and second electrode structures may create a random distribution of the materials involved.

In the above examples and embodiments various Organic-based and Siloxane-based Smectic A liquid crystal materials are used. However, other Smectic A liquid crystal materials may also be used, for example, the liquid crystal material may be a mixture of the Smectic A liquid crystal material with polymers and/or colourants. As an alternative to using ITO electrodes, a carbon-based material, such as a graphene-based material may be used.

Advantageously, devices in accordance with the above embodiments of the present invention may be used in displays. In this context the display may display information, as in prior art displays, be made specifically as a display or be part of another article, such as a glazing (for use in a building or an automotive vehicle). The display may comprise a single device in accordance with the above embodiments, or may comprise a plurality of devices in accordance with the above embodiments. When more than one device is used this may be in a modular manner, where the devices are switched individually, concurrently or consecutively, or as pixels, where the devices are switched in a pre-determined manner. The ability of the device to switch quickly due to the presence of the defect generation sites creating fringe field effects and an electric field gradient means that a large area display switches uniformly rather than from the edges. This is particularly advantageous in a glazing, for example, where the entire glazing may be switched quickly and uniformly, or where a plurality of displays are linked together to cover the outer surface of a building, for example, as an advertising billboard. These may include glass or flexible substrates, such as plastics materials (suitable materials include polycarbonate, acrylic plastics, PETG, ETFE, PET), or laminated plastic films retro-fitted onto existing glazings and/or glass products. Many other uses of such large area and modularly connected displays may also be envisaged.

Other alternatives and embodiments of the present invention will be apparent to those skilled in the art.

1. A liquid crystal device comprising:
a layer of liquid crystal material bounded by a first cell wall and a second cell wall, the first cell wall being provided with a first electrode structure and the second cell wall being provided with a second electrode structure, and the first cell wall and the second cell wall being separated by a distance d_{c}, wherein the layer of liquid crystal material is associated with a plurality of defect generation sites.

2. The liquid crystal device as claimed in claim 1,
wherein the width of at least one defect generated by a defect generation site is wd, and wherein wd>dc.

3. The liquid crystal device as claimed in claim 1, wherein the width of at least one defect generated by a defect generation site is wd, and wherein wd<5dc.

4. The liquid crystal device as claimed in claim 1, wherein the width of at least one defect generated by a defect generation site is wd, and wherein wd<dc.

5. The liquid crystal device as claimed in claim 1, wherein the spacing between at least two adjacent defects generated by defect generation sites is dd, and wherein dd>dc.

6. The liquid crystal device as claimed in claim 1, wherein the spacing between at least two adjacent defects generated by defect generation sites is dd, and wherein dd>wd.

7. The liquid crystal device as claimed in claim 1, wherein at least a first intermediate layer is provided between the layer of liquid crystal material and at least one of the first and second electrode structures.

8. The liquid crystal device as claimed in claim 7, wherein the intermediate layer is a pinning layer, and the pinning layer comprises the plurality of defect generation sites.

9. The liquid crystal device as claimed in claim 7, wherein the intermediate layer is a dielectric layer, and the dielectric layer comprises the plurality of defect generation sites.

10. The liquid crystal device as claimed in claim 1, wherein at least one of the first and second electrode structures is multiconnected, such that the electrode structure comprises a plurality of defect generation sites.

11. The liquid crystal device as claimed in claim 1, wherein both the first electrode structure and the second electrode structure are multiconnected, such that both the first and second electrode structures comprise a plurality of defect generation sites.

12. The liquid crystal device as claimed in claim 10, wherein the plurality of defect generation sites extends substantially across the electrode structure.

13. The liquid crystal device as claimed in claim 10, wherein the density of defect generation sites is approximately constant across the electrode structure.

14. The liquid crystal device as claimed in claim 10, wherein the plurality of defect generation sites comprises an array of defect generation sites.

15. The liquid crystal device as claimed in claim 10, wherein a first density of defect generation sites is present in a first region of the electrode structure and a second density of defect generation sites is present in a second region of the electrode structure, and wherein the first density is different to the second density.

16. The liquid crystal device as claimed in claim 10, wherein the width of each defect generation site in the array is substantially equal for each defect generation site in the array.

17. The liquid crystal device as claimed in claim 10, wherein the defect generation site is a through hole, having a width wh, in the electrode structure.

18. The liquid crystal device as claimed in claim 10, wherein the one of the at least first or second electrode structure comprising the defect generation sites is patterned, the pattern comprising regions of materials with different work functions, such that the differences in work functions create the defect generation sites.

19. The liquid crystal device as claimed in claim 1, wherein at least a first intermediate layer is provided between the layer of liquid crystal material and at least one of the first and second electrode structures, and wherein the liquid crystal material, the electrode structure and the intermediate layer are formed of materials or surfaces each having a work function, such that the differences in work functions create the defect generation sites.

20. The liquid crystal device as claimed in claim 1, wherein the liquid crystal material is a Smectic A liquid crystal material.

21. The liquid crystal device as claimed in claim 1, wherein the liquid crystal material is a mixture of Smectic A liquid crystal material with polymers and/or colourants.

22. The liquid crystal device as claimed in claim 1, wherein the Smectic A liquid crystal material is an Organic-based Smectic A liquid crystal material.

23. The liquid crystal device as claimed in claim 1, wherein the Smectic A liquid crystal material is a Siloxane-based Smectic A liquid crystal material.

24. The liquid crystal device as claimed in claim 1, wherein the electrodes are made of transparent metal oxide material.

25. The liquid crystal device as claimed in claim 1, wherein the transparent metal oxide material is indium tin oxide (ITO) material.

26. The liquid crystal device as claimed in claim 1, wherein the electrodes are made of carbon based material.

27. The liquid crystal device as claimed in claim 1, wherein the carbon based material is graphene material.

28. The liquid crystal device as claimed in claim 1, wherein when in use, the plurality of defect generation sites lead to the generation of an electric field gradient.

29. The liquid crystal device as claimed in claim 1, wherein at least one cell wall comprises a flexible material.

30. The liquid crystal device as claimed in claim 1, wherein at least one cell wall comprises a rigid material.

31. A display comprising at least one device as claimed in claim 1.

32. A method of preparing a liquid crystal device, the method comprising:
providing a first substrate having an electrically conductive coating that forms a first electrode structure;
providing a second substrate having an electrically conductive coating that forms a second electrode structure;
assembling the first substrate and the second substrate with a liquid crystal material to form a first cell wall and a second cell wall separated by a distance d_{c} and having a layer of liquid crystal bounded between them; and
associating the layer of liquid crystal material with a plurality of defect generation sites.

33. The method as claimed in claim 32, wherein the step of associating the layer of liquid crystal material with the plurality of defect generation sites comprises providing either an intermediate layer, wherein the intermediate layer comprises the plurality of defect generation sites, or treating the electrically conductive coating to provide a plurality of defect generation sites.

34. The method as claimed in claim 33, wherein treating the electrically conductive coating comprises removing at least a portion of the electrically conductive coating.

35. The method as claimed in claim 33, wherein treating the electrically conductive coating comprises removing at least a portion of the electrically conductive coating to create a through hole.

36. The method as claimed claim 32, wherein the step of treating the electrically conductive coating comprises using a laser.

37. The method as claimed in claim 32, wherein the step of treating the electrically conductive coating comprises using photolithography.

38. The method as claimed in claim 32, further comprising the step of treating the second electrically conductive coating on the second substrate to provide a plurality of defect generation sites.
